(19) United States
(12) Patent Application Publication
(10) Pub. No.: US 2014/0221547 A1
(43) Pub. Date: Aug. 7, 2014

(54) Thermoplastic Resin Composition and Article Using the Same

(71) Applicant: Cheil Industries Inc., Gumi-si (KR)

(72) Inventors: Young-Sin KIM, Uiwang-si (KR); Kang-Yeol PARK, Uiwang-si (KR); Seon-Ae LEE, Uiwang-si (KR); Min-Young LIM, Uiwang-si (KR)

(73) Assignee: Cheil Industries Inc., Gumi-si (KR)

(21) Appl. No.: 13/950,938

(22) Filed: Jul. 25, 2013

(30) Foreign Application Priority Data
Feb. 7, 2013 (KR) 10-2013-0014144

(51) Int. Cl. C08K 9/02

(52) U.S. Cl. CPC C08K 9/02
USPC 524/430

(57) ABSTRACT

Disclosed are a thermoplastic resin composition including (A) a transparent thermoplastic resin; and (B) a metallic particle including a glass flake coated with metal oxide, and an article using the same.

### CROSS-REFERENCE TO RELATED APPLICATION

This application claims priority to and the benefit of Korean Patent Application No. 10-2013-0014144 filed in the Korean Intellectual Property Office on Feb. 7, 2013, the entire disclosure of which is incorporated herein by reference.

### FIELD OF THE INVENTION

A thermoplastic resin composition and an article using the same are disclosed.

### BACKGROUND OF THE INVENTION

Recently, plastic exterior products with diverse colors have become increasingly popular for electronic parts, automobile parts and the like. In addition, there is increased demand for plastic exterior products with a high quality sense of touch.

Plastic exterior products usually include a plastic resin and metal particles to give a metal-like texture to the resin appearance. This is disclosed in Japanese Patent Laid-Open Publication Nos. 2001-262003 and 2007-137963, but a metal-like texture did not appear in an actual experiment.

Japanese Patent Laid-Open Publication No. 2001-262003 discloses the use of a flake-shaped metal particulate, but a weld line occurs in an actual experiment. Japanese Patent Laid-Open Publication No. 2007-137963 discloses a resin composition including a glass fiber and a metal particle, but the glass fiber causes an appearance defect in an actual experiment.

Accordingly, conventional articles formed by adding metal particles and the like to a plastic resin may not exhibit a metal-like texture and thus may not suitable replacements for painted articles.

### SUMMARY OF THE INVENTION

One embodiment of the present invention provides a resin composition that can have a metal-like texture near to that (similar to that) of a painted article while not being painted and excellent luminance with almost no flow mark and/or weld line, and an article using the same.

In one embodiment of the present invention, a thermoplastic resin composition includes (A) a transparent thermoplastic resin and (B) a metallic particle including a glass flake coated with metal oxide.

The transparent thermoplastic resin (A) may include a polycarbonate resin, a rubber modified vinyl-based copolymer resin, a polyester resin, a polyalkyl(meth)acrylate resin, a styrene-based polymer, a polyolefin resin, or a combination thereof.

The transparent thermoplastic resin (A) may have a haze of about 0.5% to about 40% measured using a 3.2 mm-thick specimen.

The transparent thermoplastic resin (A) may have a refractive index of about 1.05 to about 1.20.

The transparent thermoplastic resin (A) may have a transmittance of about 10% to about 100% measured using a 3.2 mm-thick specimen.

In the metallic particle (B), the metal oxide may be an oxide of at least one metal selected from aluminum silver, gold, and palladium.

The metallic particle (B) may have a sheet-shape.

The metallic particle (B) may have an average particle diameter of about 1 μm to about 100 μm.

The metallic particle (B) may have an average thickness of about 0.01 μm to 10 μm.

The metallic particle (B) may have a ratio of an average particle diameter relative to an average thickness ranging from about 1 to about 1,000.

The metallic particle (B) may have an aspect ratio ranging from 1 to about 20.

The metallic particle (B) may be included in an amount of about 0.1 to about 2 parts by weight based on about 100 parts by weight of the transparent thermoplastic resin (A).

The thermoplastic resin composition may have a flop index of about 10 to about 25.

The thermoplastic resin composition may have a sparkle intensity of about 5 to about 20.

The thermoplastic resin composition may have luminance of about 75% to about 100% measured based on a gloss level at an angle of about 60°.

In another embodiment of the present invention, an article using the thermoplastic resin composition is provided.

The article may have a flop index of about 10 to about 25.

The article may have a sparkle intensity of about 5 to about 20.

The article may have luminance of about 75% to about 100% measured based on a gloss level at an angle of about 60°.

The thermoplastic resin composition according to one embodiment of the present invention and an article using the same may realize a metal-like texture near to that of a painted article while not being painted, and thus can provide excellent luminance with almost no flow mark and/or weld line.

### BRIEF DESCRIPTION OF THE DRAWINGS

FIG. 1 is photograph of the article according to Example 4.

FIG. 2 is photograph of the article according to Comparative Example 1.

### DETAILED DESCRIPTION

The present invention will be described more fully hereinafter in the following detailed description of the invention, in which some but not all embodiments of the invention are described. Indeed, this invention may be embodied in many different forms and should not be construed as limited to the embodiments set forth herein; rather, these embodiments are provided so that this disclosure will satisfy applicable legal requirements.

As used herein, when a specific definition is not otherwise provided, “(meth)acrylate” refers to both “acrylate” and “methacrylate”. “(Meth)acrylic acid alkyl ester” refers to both “acrylic acid alkyl ester” and “methacrylic acid alkyl ester”, and “(meth)acrylic acid ester” refers to both “acrylic acid ester” and “methacrylic acid ester”.

As used herein, when a definition is not otherwise provided, the term “copolymerization” may refer to block copolymerization, random copolymerization, graft copolymerization, or alternate copolymerization, and the term “copolymer” may refer to a block copolymer, a random copolymer, a graft copolymer, or an alternate copolymer.

As used herein, when a specific definition is not otherwise provided, the term “particle diameter” denotes the length of a line connecting two points while passing the center point in a closed curved, and the term “closed curve” is a curved line where a point moves in one direction and returns to the departure point.

The term long diameter or major axis denotes the longest particle diameter, and a short diameter or a minor axis denotes the shortest particle diameter. The term thickness denotes a length that is perpendicular to a major axis and minor axis.

When a specific definition is not otherwise provided, the average particle diameter and average thickness is obtained by analyzing a particle itself using scanning electron microscope (SEM, S4800, Hitachi Inc.), or by sampling a part of an article including a particle and analyzing the cross-section thereof. In the latter case, longer diameters and thicknesses of greater than or equal to about 50 particles in SEM images are measured, and arithmetic means of the rest of the particles except for top 10% and bottom 10% of the particles particle are calculated.

In one embodiment of the present invention, a thermoplastic resin composition includes (A) a transparent thermoplastic resin and (B) a metallic particle including a glass flake coated with metal oxide.

Hereinafter, each component in the thermoplastic resin composition is specifically described.

### (A) Transparent Thermoplastic Resin

The transparent thermoplastic resin may be any thermoplastic resin without limitation. Examples of the transparent thermoplastic resin may include without limitation polycarbonate resins, rubber modified vinyl-based copolymer resins, polyester resins, polyalkyl(meth)acrylate resins, styrene-based polymers, polyolefin resins, and the like, and combinations thereof.

The transparent thermoplastic resin may provide basic properties to the resin composition such as impact resistance, heat resistance, flexural characteristics, tensile characteristics, and the like.

The polycarbonate resin may be prepared by reacting one or more diphenols with phosgene, halogen formate, carbonate ester, or a combination thereof.

Examples of the diphenols include without limitation 4,4′-dihydroxydiphenyl, 2,2-bis(4-hydroxyphenyl)propane (‘bisphenol-A’), 2,4-bis(4-hydroxyphenyl)-2-methylbutane, bis(4-hydroxyphenyl)methane, 1,1-bis(4-hydroxyphenyl)cyclohexane, 2,2-bis(3-chloro-4-hydroxyphenyl)propane, 2,2-bis(3,5-dimethyl-4-hydroxyphenyl)propane, 2,2-bis(3,5-dichloro-4-hydroxyphenyl)propane, 2,2-bis(3,5-dibromo-4-hydroxyphenyl)propane, bis(4-hydroxyphenyl)sulfoxide, bis(4-hydroxyphenyl)ketone, bis(4-hydroxyphenyl)ether, and the like, and combinations thereof. In exemplary embodiments, 2,2-bis(4-hydroxyphenyl)propane, 2,2-bis(3,5-dichloro-4-hydroxyphenyl)propane and/or 1,1-bis(4-hydroxyphenyl)cyclohexane may be used, for example 2,2-bis(4-hydroxyphenyl)propane may be used.

The polycarbonate resin may have a weight average molecular weight of about 10,000 g/mol, to about 200,000 g/mol, for example about 15,000 g/mol to about 80,000 g/mol, without limitation.

The polycarbonate resin may be a mixture of copolymers obtained using two or more dipenols that differ from each other. The polycarbonate resin may include a linear polycarbonate resin, a branched polycarbonate resin, a polyestercarbonate copolymer resin, and the like, as well as combinations thereof.

The linear polycarbonate resin may include a bisphenol-A-based polycarbonate resin. The branched polycarbonate resin may be produced by reacting a multi-functional aromatic compound such as trimellitic anhydride, trimellitic acid, and the like with one or more diphenols and a carbonate. The multi-functional aromatic compound may be included in an amount of about 0.05 to about 2 mol % based on the total weight of the branched polycarbonate resin. The polyester carbonate copolymer resin may be produced by reacting difunctional carboxylic acid with one or more diphenols and a carbonate. The carbonate may include a diaryl carbonate such as diphenyl carbonate, ethylene carbonate, and the like, and combinations thereof.

The rubber modified vinyl-based graft copolymer resin is a copolymer wherein about 5 wt % to about 95 wt % of a vinyl-based polymer is grafted on about 5 wt % to about 95 wt % of a rubbery polymer.

Examples of the rubbery polymer may include without limitation butadiene rubbers, acrylic rubbers, ethylene/propylene rubbers, styrene/butadiene rubbers, acrylonitrile/butadiene rubbers, isoprene rubbers, ethylene-propylene-diene terpolymer (EPDM) rubbers, polyorganosiloxane/polyalkyl(meth)acrylate rubber composites, and the like, and combinations thereof.

The vinyl-based polymer may be a polymer of about 50 wt % to about 95 wt % of a first vinyl-based monomer, such as but not limited to an aromatic vinyl monomer, an acrylic-based monomer, a heterocyclic monomer, or a combination thereof; and about 5 to about 50 wt % of a second vinyl-based monomer, such as but not limited to an unsaturated nitrile monomer, an acrylic-based monomer, a heterocyclic monomer, or a combination thereof.

Examples of the aromatic vinyl monomer may include without limitation styrene, C1 to C10 alkyl-substituted styrene, halogen-substituted styrene, and the like, and combinations thereof. Examples of the alkyl-substituted styrene may include without limitation o-ethyl styrene, m-ethyl styrene, p-ethyl styrene, α-methyl styrene, and the like, and combinations thereof.

Examples of the acrylic-based monomer may include without limitation (meth)acrylic acid alkyl esters, (meth)acrylic acid esters, and the like, and combinations thereof. As used herein, the term alkyl may be a C1 to C10 alkyl. Examples of the (meth)acrylic acid alkyl ester may include without limitation methyl(meth)acrylate, ethyl(meth)acrylate, propyl(meth)acrylate, butyl(meth)acrylate, and the like, and combinations thereof. In exemplary embodiments, methyl(meth)acrylate may be used. Examples of the (meth)acrylic acid ester may include without limitation (meth)acrylate, and the like, and combinations thereof.

Examples of the heterocyclic monomer may without limitation maleic anhydride, C1-C10 alkyl- and/or phenyl N-substituted maleimides, and the like, and combinations thereof.

Examples of the unsaturated nitrile monomer may include without limitation acrylonitrile, methacrylonitrile, ethacrylonitrile, and the like, and combinations thereof.

When the rubber modified vinyl-based graft copolymer resin is prepared, a rubber particle may have a particle diameter of about 0.1 μm to about 1 μm, which can improve impact resistance of the resin and surface characteristics of an article using the same. In this case, excellent impact strength may be ensured.

The rubber modified vinyl-based graft copolymer resin may be used singularly or as a mixture of two or more.

Examples of the rubber modified vinyl-based copolymer resin may include without limitation a copolymer in which styrene, acrylonitrile, and/or methyl(meth)acrylate are graft-copolymerized on a butadiene rubber, an acrylic rubber, or a styrene/butadiene rubber.

Methods of preparing the rubber modified vinyl-based copolymer resin are widely known to a person skilled in the art. Examples of such methods include without limitation emulsion polymerization, suspension polymerization, solution polymerization, massive polymerization, and the like.

The polyester resin can be an aromatic polyester resin, such as a condensation-polymerized resin obtained from melt polymerization of terephthalic acid or alkylester terephthalate and a C2 to C10 glycol component. As used herein, the alkyl may be a C1 to C10 alkyl.

Examples of the aromatic polyester resin may include without limitation a polyethylene terephthalate resin, a polytrimethylene terephthalate resin, a polybutylene terephthalate resin, a polyhexamethylene terephthalate resin, a polycyclohexane dimethylene terephthalate resin, a polyester resin modified into a non-crystalline resin by mixing the resins with another monomer, and the like, and combinations thereof. Among these, a polyethylene terephthalate resin, a polytrimethylene terephthalate resin, a polybutylene terephthalate resin, and/or non-crystalline polyethylene terephthalate resin may be used, for example, a polybutylene terephthalate resin and/or polyethylene terephthalate resin may be used.

The polyethylene terephthalate resin may be a condensation-polymerized polymer obtained through a direct ester reaction or an ester exchange reaction of ethylene glycol monomer and terephthalic acid or dimethyl terephthalate monomer.

To increase the impact strength of the polyethylene terephthalate resin, the polyethylene terephthalate resin may be copolymerized with polytetramethylene glycol (PTMG), polyethylene glycol (PEG), polypropylene glycol (PPG), a low molecular-weight aliphatic polyester and/or aliphatic polyamide, and the like and combinations thereof, and/or it may be used in the form of a modified polyethylene terephthalate resin obtained by blending with a component improving impact strength.

The polyalkyl(meth)acrylate resin may be obtained by polymerizing a monomer material including an alkyl(meth)acrylate through a known polymerization method, such as a suspension polymerization method, a massive polymerization method, an emulsion method and the like.

The alkyl(meth)acrylate may have a substituted or unsubstituted C1 to C10 alkyl group. Examples of the alkyl(meth)acrylate may include without limitation methyl(meth)acrylate, ethyl(meth)acrylate, butyl(meth)acrylate, glycidyl(meth)acrylate, hydroxyethyl(meth)acrylate, and the like, and combinations thereof.

The polyalkyl(meth)acrylate may have a weight average molecular weight of about 10,000 g/mol to about 200,000 g/mol, for example about 15,000 g/mol to about 150,000 g/mol. When the polyalkyl(meth)acrylate has a weight average molecular weight within the above range, hydrolysis resistance, scratch resistance, workability, and the like may be improved.

The styrene-based polymer may be a polymer including about 20 wt % to about 100 wt % of a styrene-based monomer; and about 0 wt % to about 80 wt % of a vinyl-based monomer. Example of the vinyl-based monomer may include without limitation acrylic-based monomers, heterocyclic monomers, unsaturated nitrile monomers, and the like, and combinations thereof. The styrene-based polymer may be for example a rubber modified styrene-based polymer such as a rubber-reinforced polystyrene resin (HIPS).

Examples of the styrene-based monomer may include without limitation styrene, C1 to C10 alkyl-substituted styrene, halogen-substituted styrene, and the like, and combinations thereof. Examples of the alkyl-substituted styrene may include without limitation o-ethyl styrene, m-ethyl styrene, p-ethyl styrene, α-methyl styrene, and the like, and combinations thereof.

Examples of the acrylic-based monomer may include without limitation (meth)acrylic acid alkyl esters, (meth)acrylic acid esters, and the like, and combinations thereof. As used herein, the alkyl may be a C1 to C10 alkyl. Examples of the (meth)acrylic acid alkyl ester may include without limitation methyl(meth)acrylate, ethyl(meth)acrylate, propyl(meth)acrylate, butyl(meth)acrylate, and the like, and combinations thereof. In exemplary embodiments, methyl(meth)acrylate may be used. Examples of the (meth)acrylic acid ester may include without limitation (meth)acrylates, and the like.

Examples of the heterocyclic monomer may include without limitation maleic anhydride, C1-C10 alkyl- and/or phenyl N-substituted maleimides, and the like, and combinations thereof.

Examples of the unsaturated nitrile monomer may include without limitation acrylonitrile, methacrylonitrile, ethacrylonitrile, and the like, and combinations thereof.

Examples of the styrene-based polymer may include without limitation a copolymer of a styrene-based monomer and an unsaturated nitrile monomer, a copolymer of a styrene-based monomer and an acrylic-based monomer, a copolymer of a styrene-based monomer, an unsaturated nitrile monomer, and an acrylic-based monomer, a styrene-based homopolymer of a styrene-based monomer, and the like, and combinations thereof.

The styrene-based polymer may have a weight average molecular weight of about 40,000 g/mol to about 500,000 g/mol.

The styrene-based polymer may be prepared using emulsion polymerization, suspension polymerization, solution polymerization, massive polymerization, and the like.

Examples of the polyolefin resin may include without limitation polyethylene (PE) resins, polypropylene (PP) resins, copolymers thereof, and the like and combinations thereof.

The transparent thermoplastic resin may be an alloy including two or more kinds of resins.

The transparent thermoplastic resin may have a haze of about 0.5% to about 40% measured using a 3.2 mm-thick specimen. For example, the transparent thermoplastic resin may have a haze of about 0.5% to about 40%, about 0.5% to about 35%, about 0.5% to about 30%, about 0.5% to about 25%, about 0.5% to about 20%, or about 0.5% to about 15%. In some embodiments, the transparent thermoplastic resin may have a haze of about 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40%. Further, according to some embodiments of the present invention, the transparent thermoplastic resin may have a haze from about any of the foregoing amounts to about any other of the foregoing amounts.

The haze is calculated according to the following Calculation Equation 1.

Haze(%)={diffused light/(diffused and transmitted light+parallel transmitted light)}×100 [Calculation Equation 1]

When the transparent thermoplastic resin has a haze within the above range measured using a 3.2 mm-thick specimen, the thermoplastic resin composition including the metallic particle and the article using the thermoplastic resin composition may have a metal-like texture that is similar to that of a painted article without being painted and can have a very high luminance due to high transparency.

The transparent thermoplastic resin may have a refractive index of about 1.05 to about 1.20. When the transparent thermoplastic resin has a refractive index within the above range, the thermoplastic resin composition including the metallic particle and the article using the thermoplastic resin composition can have an improved metal-like texture and very high luminance.

The transparent thermoplastic resin may have transmittance of about 10% to about 100% measured using a 3.2 mm-thick specimen. The transmittance denotes the fraction of incident light that passes through an article, and may be calculated according to the following Calculation Equation 2.

Transmittance(%)=(transmission energy/incident energy)×100 [Calculation Equation 2]

When the transparent thermoplastic resin has a refractive index and transmittance within the above ranges, the thermoplastic resin composition including the metallic particle and the article using the thermoplastic resin composition can have an improved metal-like texture and very high luminance.

### (B) Metallic Particle

The metallic particle is a particle including a glass flake coated with metal oxide. The entire surface of the glass flake is coated with metal oxide.

A conventional metal particle has different colors on the reflection surface (flat surface) and on the thickness surface from each other and thus, causes an appearance defect such as a flow mark, a weld line, or the like in an article including the same.

In the present invention, the metallic particle includes a glass flake coated with a metal oxide on the entire surface of the glass flake. Accordingly, the metallic particle used in the present invention can have a small reflective light difference at any angle and a relatively small color difference between the flat and thickness surfaces and thus, can cause almost no color difference in flow mark or weld line of an article including the same.

In addition, the metallic particle used in the present invention can have high flatness because it can be a glass flake coated with a metal oxide on the flat surface of the glass flake and thus, can realize excellent luminance of an article including the same.

The glass flake may be any conventional glass flake without any particular limit. For example, the glass flake may include a common glass material such as but not limited to glass for a glass plate, E-glass, lead glass, acid-resistant glass for a container, and the like, and combinations thereof.

The metal oxide may be an oxide of at least one metal. Examples of the metal include without limitation aluminum, silver, gold, palladium, and the like, and combinations thereof. Examples of the metal oxide may include without limitation aluminum oxide, silver oxide, gold oxide, and/or palladium oxide.

The metallic particle may have a sheet-shape. When the metallic particle has a sheet shape, the metallic particle can have a flat surface, and thus improved flatness, which can improve luminance of an article including the same.

The metallic particle may have an average particle diameter of about 1 μm to about 100 μm, for example about 1 μm to about 90 μm, about 1 μm to about 80 μm, about 10 μm to about 100 μm, about 20 μm to about 100 μm, or about 30 μm to about 100 μm.

The average particle diameter and average thickness is obtained by analyzing a particle itself using scanning electron microscope (SEM, S4800, Hitachi Inc.), or by sampling a part of an article including a particle and analyzing the cross-section thereof.

In the latter case, longer diameters and thicknesses of greater than or equal to about 50 particles in SEM images are measured, and arithmetic means of the rest of the particles except for top 10% and bottom 10% of the particles particle are calculated.

When the metallic particle has an average particle diameter within the above range, the thermoplastic resin composition including the same may have an improved metal-like texture and luminance and can have minimal or no flow mark, weld line and the like during injection molding.

The metallic particle (B) may have an average thickness of about 0.01 μm to about 10 μm, for example about 0.01 μm to about 9 μm, about 0.01 μm to about 8 μm, about 0.01 μm to about 7 μm, about 0.01 μm to about 6 μm, about 0.01 μm to about 5 μm, or about 0.01 μm to about 4 μm. In some embodiments, the metallic particle (B) may have an average thickness of about 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, or 10 μm. Further, according to some embodiments of the present invention, the metallic particle (B) may have an average thickness from about any of the foregoing thicknesses to about any other of the foregoing thicknesses.

The thickness denotes a length that is perpendicular to a flat surface of the metallic particle. The average thickness may be obtained by analyzing a metallic particle itself using a scanning electron microscope, or by sampling a part of an article including a metallic particle and analyzing the cross-section thereof.

In the latter case, longer diameters and thicknesses of greater than or equal to about 50 particles in SEM images are measured, and arithmetic means of the rest of the particles except for top 10% and bottom 10% of the particles particle are calculated.

When the metallic particle has an average thickness within the above range, the thermoplastic resin composition including the same can have an improved metal-like texture and luminance, and can have minimal or no flow mark, weld line and the like during injection molding of the thermoplastic resin composition.

The metallic particle may have a ratio of an average particle diameter relative to an average thickness ranging from about 1 to about 1,000, for example about 1 to about 700, about 1 to about 500, about 10 to about 1,000, or about 50 to about 1,000. In this case, the metallic particle can have an appropriate flat surface and thus, an article including the same can have improved luminance and metal-like texture.

The metallic particle may have an aspect ratio of about 1 to about 20, for example about 1 to about 15. The aspect ratio denotes a ratio between a short diameter and long diameter on a flat surface of the metallic particle. When the metallic particle has an aspect ratio within the above ranges, the metallic particle can have an appropriate flat surface and thus, an article including the same can have improved luminance and metal-like texture.

The thermoplastic resin composition may include the metallic particle in an amount of about 0.1 to about 2 parts by weight based on about 100 parts by weight of the transparent thermoplastic resin (A). In some embodiments, the thermoplastic resin composition can include the metallic particle in an amount of about 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, or 2.0 parts by weight. Further, according to some embodiments of the present invention, the amount of the metallic particle can be in a range from about any of the foregoing amounts to about any other of the foregoing amounts.

When the thermoplastic resin composition includes the metallic particle in an amount within the above range, the thermoplastic resin composition can have excellent luminance and metal-like texture and simultaneously may have minimal or no appearance problems such as flow mark, weld line, and the like.

The metallic particle may be prepared, for example, by dipping glass flake in a solution including metal oxide.

A method of preparing the metallic particle is simple and favorable in cost.

### (C) Other Additive(s)

The thermoplastic resin composition may further include one or more additives. Examples of the additives may include without limitation antibacterial agents, heat stabilizers, antioxidants, release agents, light stabilizers, surfactants, coupling agents, plasticizers, admixtures, colorants, stabilizers, lubricants, anti-static agents, coloring aids, flame proofing agents, weather-resistance agents, ultraviolet (UV) absorbers, ultraviolet (UV) blocking agents, nucleating agents, adhesion aids, adhesives, and the like, and combinations thereof.

Examples of the antioxidant may include without limitation phenol antioxidants, phosphite antioxidants, thioether antioxidants, amine antioxidants, and the like, and combinations thereof.

Examples of the release agent may include without limitation fluorine-containing polymers, silicon oils, stearic metal salts, montanic metal salts, montanic ester waxes, polyethylene waxes, and the like, and combinations thereof.

Examples of the weather-resistance agent may include without limitation benzophenone-type weather-resistance agents, amine-type weather-resistance agents, and the like, and combinations thereof.

Examples of the colorant may include without limitation dyes, pigments, and the like, and combinations thereof.

Examples of the ultraviolet (UV) ray blocking agent may include without limitation titanium oxide (TiO₂), carbon black, and the like, and combinations thereof.

Examples of the nucleating agent may include without limitation talc, clay, and the like, and combinations thereof.

The additive may be included in a predetermined amount as long as it does not deteriorate the properties of the thermoplastic resin composition. For example, the additive may be included in an amount of less than or equal to about 40 parts by weight, for example about 0.1 to about 30 parts by weight, based on about 100 parts by weight of the transparent thermoplastic resin.

The above-described thermoplastic resin composition may be prepared by any well-known method of preparing a resin composition. For example, each component according to one embodiment of the present invention can be simultaneously mixed with one or more of the optional additives. The mixture can be melt-extruded and prepared into pellets.

According to another embodiment of the present invention, an article manufactured using the above-described thermoplastic resin composition is provided.

The article may be manufactured using various known processes such as but not limited to injection-molding, blow molding, extrusion molding, thermal molding, and the like, using the thermoplastic resin composition. The article may have almost no flow mark and/or weld line problem but can have a metal-like texture appearance. The composition accordingly can be used in the production of various products, including without limitation exterior plastic products such as IT products, home appliances, interior/exterior auto parts, furniture, interior items, miscellaneous goods, and the like.

Accordingly, the article according to one embodiment of the present invention can have an excellent metal-like texture. In the present invention, the metal-like texture is evaluated using a flop index. The flop index may be obtained by the following Equation 1.

FI=2.69×(L(15°)−L(110°))^{1.11}/L(45°)^{0.86} [Equation 1]

In Equation 1, L*(x°) indicates luminance measured at x°. The flop index is obtained by measuring reflectivity change while an angle of reflection is revolved and by specifically, measuring luminance (L*) at each reflection angle of about 15°, 45° and 110° an then, calculating the measurements according to the Equation 1.

For example, one surface having no metal-like texture has a flop index of 0, a metal has a flop index ranging from about 15 to about 17, a metal-like texture coating used for an automobile body paint has a flop index of about 11; and the metal-like texture sensed by the naked eye has a flop index of greater than or equal to about 6.5.

An article according to one embodiment of the present invention may have a flop index of about 10 to about 25, for example about 11 to about 25, and as another example about 12 to about 25. The flop index is measured by using a BYK-Mac spectrophotometer made by BYK Inc.

The article according to one embodiment also can have excellent metal particle texture. The metal particle texture uses a sparkle intensity as an index. The sparkle intensity may be obtained according to the following Equation 2.

$$Δ {S}_{total} = \sqrt{\frac{Δ {S}_{15 °}^{2} + Δ {S}_{45 °}^{2} + Δ {S}_{75 °}^{2} + Δ {G}^{2}}{4}} \qquad [ Equation 2 ]$$

In Equation 2, ΔS(x°) indicates sparkle intensity measured at x°, and ΔG is diffusion of each ΔS(x°) and indicates graininess of metal particles. The sparkle intensity (ΔSₜₒₜₐₗ) of the article is calculated according to the Equation 2 after measuring each sparkle intensity at about 15°, 45°, and 75°.

The sparkle intensity calculated according to Equation 2 is obtained by combining the following factors.

### [Four Factors]

\textcircled{1} Reflectivity of individual metal particle

\textcircled{2} Amounts of metal particle

\textcircled{3} Sizes of metal particle

\textcircled{4} Orientation of metal particle

The article according to one embodiment of the present invention may have a sparkle intensity of about 5 to about 20, for example, about 5 to about 19, about 5 to about 18, about 5 to about 17, or about 5 to about 16. The sparkle intensity is measured by using an MA98 multi-angle spectrophotometer made by X-Rite Inc.

The article according to one embodiment of the present invention may have improved luminance.

In the present invention, the luminance as an index showing brightness such as metal gloss is measured using a gloss level at about 60° with an UGV-6P digital variable glossmeter (SUGA Inc.).

The article according to one embodiment of the present invention may have luminance of about 75% to about 100%, for example about 80% to about 100%, and as another example about 75% to about 95%.

Hereinafter, the present invention is illustrated in more detail with reference to examples. These examples, however, are not in any sense to be interpreted as limiting the scope of the invention.

### Examples 1 to 5 and Comparative Examples 1 to 7

Each component in the following Table 1 is mixed in an amount provided in the following Table 1, and the mixtures are extruded and processed, preparing pellet-shaped resins. The extrusion is performed by using a twin-screw extruder having L/D=29 and a diameter of 45 mm and setting a barrel temperature at 200 to 230° C.

TABLE 1

| | | Examples | | | | | Comparative Examples | | | | | | |
|---|---|---|---|---|---|---|---|---|---|---|---|---|---|
| | | 1 | 2 | 3 | 4 | 5 | 1 | 2 | 3 | 4 | 5 | 6 | 7 |
| (A) | | 100 | 100 | 100 | 100 | 100 | 100 | 100 | 100 | 100 | 100 | 100 | 100 |
| Transparent | | | | | | | | | | | | | |
| thermoplastic | | | | | | | | | | | | | |
| resin | | | | | | | | | | | | | |
| (A′) Opaque | | — | — | — | — | — | — | — | — | — | — | 100 | — |
| thermoplastic | | | | | | | | | | | | | |
| resin | | | | | | | | | | | | | |
| (B) | (B-1) | 0.1 | 0.2 | 0.3 | 0.5 | 1.0 | — | — | — | — | — | 0.5 | — |
| Particle | (B-2) | — | — | — | — | — | 0.5 | 1.0 | 2.0 | — | — | — | — |
| | (B-3) | — | — | — | — | — | — | — | — | 0.5 | 1.0 | — | — |

The amounts of (B-1) to (B-2) in Table 1 are parts by weight based on 100 parts by weight of the (A) or (A′). Comparative Example 7 in Table 1 is an aluminum-painted article.

Each component in Table 1 is illustrated as follows.

(A) Transparent Thermoplastic Resin Composition

An acrylonitrile-butadiene-styrene-methylmethacrylate resin having a refractive index of 1.52 and a haze of 1.7% at a thickness of 3.2 mm, TX-0510T made by Cheil Industries Inc. is used.

(A′) Opaque Thermoplastic Resin Composition

SD-0150 made by Cheil Industries Inc., an acrylonitrile-butadiene-styrene resin, is used.

(B) Particle

(B-1) A metallic particle having an average particle diameter of 80 μm and an average thickness of 1 μm, made by Young Biochemiclas Co., Ltd., and prepared by dipping a glass flake in an aluminum oxide solution, so that the glass flake is coated with the aluminum oxide is used.

(B-2) An aluminum particle having an average particle diameter of 100 μm, an average thickness of 1 μm, and an amorphous plate shape and made by Nihonboitz is used.

(B-3) An aluminum particle having an average particle diameter of 8 μm, an average thickness of 0.1 μm, and an amorphous plate shape and made by Silberline Manufacturing Co., Inc. is used.

### Evaluation Examples

The pellets are dried at 80° C. for 4 hours with a 6 Oz injection molding machine. The injection molding machine is set at a cylinder temperature ranging from 220° C. to 250° C., a molding temperature of 100° C. and a molding cycle time of 30 seconds, and a mold with two gates is used to generate a weld line on the surface of an article by injection-molding article specimens (width×length×thickness=100 mm×150 mm×3 mm). The article specimen of Comparative Example 7 is painted with aluminum. Various properties of the article specimens are measured using the following methods. The results are provided in the following Table 3.

(1) Flop Index

A flop index is measured by using a BYK-Mac spectrophotometer made by BYK Inc.

(2) Sparkle Intensity

Sparkle intensity is measured by using a MA98 multi-angle spectrophotometer made by X-Rite, Inc.

(3) Gloss Level

A gloss level at 60° is measured by using an UGV-6P digital variable glossmeter made by SUGA Test Instruments Co., Ltd. to evaluate luminance.

(4) Article Appearance

Appearance of an article is examined with the naked eye in order to evaluate generation of a flow mark and a weld line according to injection molding. The article appearance is evaluated according to a reference provided in the following Table 2.

TABLE 3

| | | Examples | | | | | Comparative Examples | |
|---|---|---|---|---|---|---|---|---|
| | | 1 | 2 | 3 | 4 | 5 | 1 | 2 |
| Flop index | | 12 | 13 | 14 | 15 | 15 | 4 | 5 |
| Sparkle intensity | | 8 | 9 | 10 | 10 | 10 | 6 | 7 |
| Luminance (%) | | 80 | 82 | 87 | 90 | 92 | 66 | 60 |
| Article | Flowmark | 4 | 4 | 3 | 3 | 3 | 4 | 3 |
| appearance | Weld line | 4 | 3 | 3 | 3 | 3 | 4 | 3 |

| Comparative Examples | | | | |
|---|---|---|---|---|
| 3 | 4 | 5 | 6 | 7 |

| Flop index | | 6 | 9 | 11 | 8 | 15 |
|---|---|---|---|---|---|---|
| Sparkle intensity | | 8 | 2 | 3 | 8 | 10 |
| Luminance (%) | | 74 | 65 | 60 | 70 | 90 |
| Article | Flowmark | 3 | 2 | 1 | 3 | 4 |
| appearance | Weld line | 3 | 1 | 1 | 3 | 4 |

Referring to Table 3, the articles according to Comparative Examples 1 to 3 exhibit excellent appearance but sharply deteriorated flop index, sparkle intensity, and luminance.

The articles according to Comparative Examples 4 and 5 exhibit very unsatisfactory flop index, sparkle intensity, and luminance and in particular, unsatisfactory appearance.

In addition, the article using an opaque thermoplastic resin according to Comparative Example 6 exhibits excellent appearance but deteriorated flop index, sparkle intensity, and luminance like the articles according to Comparative Examples 1 to 3.

On the other hand, the articles according to Examples 1 to 5 exhibit a flop index ranging from 12 to 15 and a similar metal-like texture to that of the painted article according to Comparative Example 7.

In addition, the articles exhibit sparkle intensity ranging from 8 to 10 and similar sparkle intensity to that of the painted article according to Comparative Example 7.

In addition, the articles exhibit luminance ranging from 80 to 92, which is remarkably excellent compared with that of the article according to the Comparative Examples. For example, the articles according to Examples 4 to 5 exhibit similar or better luminance than that of the painted article according to Comparative Example 7.

In addition, the articles according to Examples 4 to 5 exhibit a rating of 3 or 4 of an appearance characteristic index such as a flow mark, a weld line, and the like, which is almost similar appearance characteristics to those of the article according to Comparative Example 7.

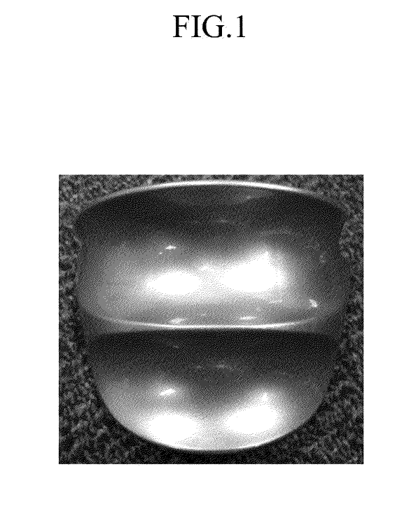

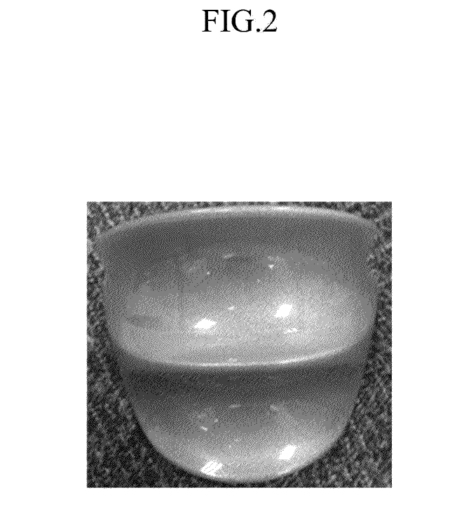

FIG. 1 is a photograph of the article according to Example 4, and FIG. 2 is a photograph of the article according to Comparative Example 1. Comparing the photographs, FIG. 1 shows that the article according to Example 4 exhibits a similar metal-like texture, sparkle intensity, and luminance to those of a painted article and excellent appearance characteristics such as a flow mark and the like.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A thermoplastic resin composition, comprising
(A) a transparent thermoplastic resin; and
(B) a metallic particle including a glass flake coated with metal oxide.

2. The thermoplastic resin composition of claim 1, wherein the transparent thermoplastic resin (A) comprises a polycarbonate resin, a rubber modified vinyl-based copolymer resin, a polyester resin, a polyalkyl(meth)acrylate resin, a styrene-based polymer, a polyolefin resin, or a combination thereof.

3. The thermoplastic resin composition of claim 1, wherein the transparent thermoplastic resin (A) has a haze of about 0.5% to about 40% measured using a 3.2 mm-thick specimen.

4. The thermoplastic resin composition of claim 1, wherein the transparent thermoplastic resin (A) has a refractive index of about 1.05 to about 1.20.

5. The thermoplastic resin composition of claim 1, wherein the transparent thermoplastic resin (A) has a transmittance of about 10% to about 100% measured using a 3.2 mm-thick specimen.

6. The thermoplastic resin composition of claim 1, wherein the metal oxide is an oxide of at least one metal selected from aluminum silver, gold, or palladium.

7. The thermoplastic resin composition of claim 1, wherein the metallic particle (B) has a sheet-shape.

8. The thermoplastic resin composition of claim 1, wherein the metallic particle (B) has an average particle diameter of about 1 μm to about 100 μm.

9. The thermoplastic resin composition of claim 1, wherein the metallic particle (B) has an average thickness of about 0.01 μm to 10 μm.

10. The thermoplastic resin composition of claim 1, wherein the metallic particle (B) has a ratio of an average particle diameter relative to an average thickness ranging from about 1 to about 1,000.

11. The thermoplastic resin composition of claim 1, wherein the metallic particle (B) has an aspect ratio ranging from about 1 to about 20.

12. The thermoplastic resin composition of claim 1, comprising the metallic particle (B) in an amount of about 0.1 to about 2 parts by weight based on about 100 parts by weight of the transparent thermoplastic resin (A).

13. An article using the thermoplastic resin composition according to claim 1.

14. The article of claim 13, wherein the article has a flop index of about 10 to about 25, a sparkle intensity of about 5 to about 20, and luminance of about 75% to about 100% measured based on a gloss level at an angle of about 60°.
